(19) United States
(12) Patent Application Publication
(10) Pub. No.: US 2014/0164225 A1
(43) Pub. Date: Jun. 12, 2014

(54) METHOD AND APPARATUS FOR CONTENT DISTRIBUTION AND DEFERRED PAYMENT OVER A WIRELESS NETWORK

(71) Applicant: Javier Cardona, San Francisco, CA (US)

(72) Inventor: Javier Cardona, San Francisco, CA (US)

(21) Appl. No.: 13/856,982

(22) Filed: Apr. 4, 2013

Related U.S. Application Data
(60) Provisional application No. 61/734,194, filed on Dec. 6, 2012.

(51) Int. Cl. G06Q 20/32

(52) U.S. Cl. CPC G06Q 20/32
USPC 705/39

(57) ABSTRACT

A method and apparatus are disclosed herein for content distribution and deferred payment over a wireless network. In one embodiment, the method comprises: receiving content at a first mobile device in a first network directly from a second mobile device in the first network, making use of the content by the first mobile device while deferring payment for the content due to network access being unavailable to a remote license server in a second network different than the first network, and contacting the remote license server when the first mobile device gains network access to the second network to cause payment to be made for the content.

### PRIORITY

The present patent application claims priority to and incorporates by reference the corresponding provisional patent application Ser. No. 61/734,194, titled, “Magnet Gaming Portal,” filed on Dec. 6, 2012.

### FIELD OF THE INVENTION

Embodiments of the present invention relate to content distribution in a wireless network. More particularly, embodiments of the present invention relate to distributing content in a wireless network while deferring payment for the content until network access allows for notifying that content distribution has occurred and a payment transaction for the content should occur.

### BACKGROUND OF THE INVENTION

Today, in order to obtain content such as applications, games, music, and movies, an individual often uses their computer or mobile device to contact an application store or other content provider via a network connection. The user selects the content they desire and pays for the content through the application store. Thereafter, the content provider sends the content to the user's device or permits the user's device to download the content.

A problem occurs if the user is unable to gain access to the application store or other content provider. This may be due to a number of different reasons, such as, for example, because of a lack of network access and/or data plan limitations that limit the amount of data that can be downloaded. This would prevent the user from downloading the content they desire.

Subsequently, when the individual wants to make use of the content, the application that controls access to the content contacts a remote licensing server to obtain the license status of the content. The contact with the licensing server usually occurs over a network connection. If the content is licensed already, the licensing server sends a notification to that effect to the user's device and the user is able to use the content.

Another problem occurs if an individual obtains the content, but cannot gain access to the licensing server to verify that a license exists. In such a case, the user is prevented from using the content. This is because the application that controls access to the content has logic that prevents use unless it receives an indication that the content is licensed. Without receiving the indication that the content is licensed, the application prevents the content from being used.

### SUMMARY OF THE INVENTION

A method and apparatus are disclosed herein for content distribution and deferred payment over a wireless network. In one embodiment, the method comprises: receiving content at a first mobile device in a first network directly from a second mobile device in the first network, making use of the content by the first mobile device while deferring payment for the content due to network access being unavailable to a remote license server in a second network different than the first network, and contacting the remote license server when the first mobile device gains network access to the second network to cause payment to be made for the content.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a wireless network.

FIG. 2 illustrates an example of content distribution and deferred payment in a mesh network.

FIG. 3 illustrates a display of a mobile phone indicating that no content is available for use.

FIG. 4 illustrates a display of a mobile device populated with the titles of games from other mobile devices in a mesh network that are distributable to the mobile device.

FIG. 5 illustrates a user selecting one of multiple games from the populated display from advertisements from other mobile devices in a mesh network.

FIG. 6 illustrates a pop-up menu that is displayed in response to selecting one game from the list of games on a display of a mobile device.

FIG. 7 is one embodiment of a state diagram that illustrates the transitions for a process of obtaining content and tracking the licensing of such content.

FIG. 8 illustrates one embodiment of messaging that is used to implement portions of the obtaining and licensing content.

FIG. 9A is a flow diagram of one embodiment of a process for distributing content and deferring payment for the content.

FIG. 9B is a flow diagram of an alternative embodiment of a process for distributing content and deferring payment for the content.

FIG. 10 is a block diagram of one embodiment of a mobile device.

### DETAILED DESCRIPTION OF THE PRESENT INVENTION

A method and apparatus for distributing content and deferring payment for the content are disclosed. In one embodiment, the content distribution occurs between devices (e.g., mobile devices) in a network (e.g., a mesh network). If an individual desires to have some type of content, yet does not have network access (e.g., Internet access) or for when access is limited in bandwidth or total amount of data to download in a period of time, to obtain such content from traditional sources such as an application store or server, they can obtain the content from other devices in their vicinity that have the content and thereafter use and/or pay for the content.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

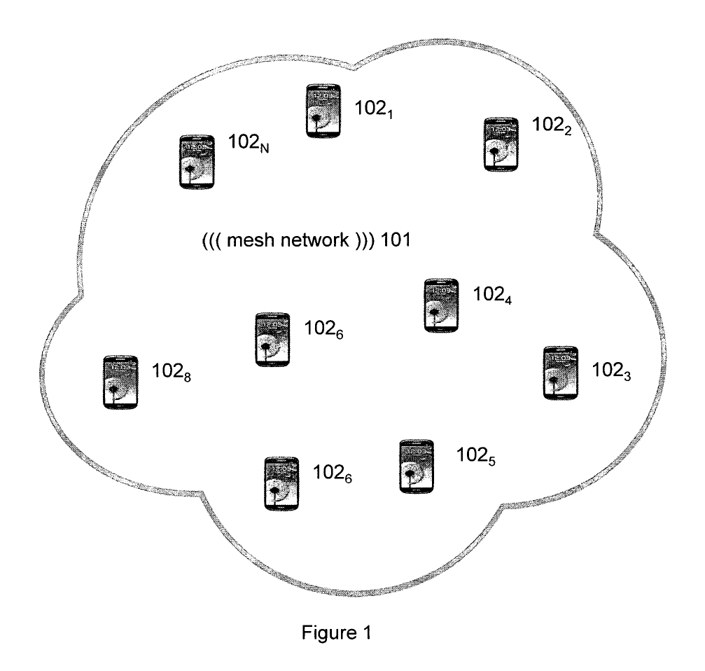

A wireless mesh network having multiple mobile devices (e.g., mobile phones, tablets, etc.) that communicate with each other is described. FIG. 1 illustrates one embodiment of a mesh network 101 with mobile devices 102_{1-N}. Although embodiments of the present invention are disclosed in conjunction with the use of a wireless mesh network, other types of wireless networks such as WiFi and WiFi Direct may be employed. Referring to FIG. 1, mobile devices 102_{1-N} communicate with each other when they are within each other's vicinity using mesh network 101.

In one embodiment, the mobile devices join the mesh network by sending announcement messages that announce or advertise their presence and their distributable content (e.g., movies, music, games, media, etc.). Each mobile device discovers other mobile devices in mobile devices that are within their vicinity (e.g., within a predetermined distance, within range of the announcement messages, etc.). In one embodiment, each of the devices represents a node in the mesh network and has a unique ID derived from the MAC address of its wireless interface. Therefore, there is a unique ID associated with every one of those nodes. This unique ID facilitates the mobile device being recognized as a previous member of the mesh network in case the mobile device leaves and then rejoins the network.

In one embodiment, the mesh network software used by each of the mobile devices is open80211s, the open mesh stack that is part of the Linux kernel version 3.8.

In one embodiment, each mobile device in mesh network 101 is operable to receive information about content that is available from the other mobile devices and display that information on their display. In one embodiment, the content is displayed as a list. In another embodiment, the content is displayed as a series of thumbnails. In yet another embodiment, the content is displayed as a list describing the movie, duration, director, etc. Each mobile device allows a user to select from the available content to select which content that is desired. In response to the selection, a mobile device generates a request for the content to be sent to the mobile device that has the content available. Upon receiving the request, the mobile device with the content sends the content to the requesting mobile device.

In one embodiment, the content includes recommendations on other content such as games, movies, etc. that may be used to facilitate a proximity-based recommendation system or network. Since people in the wireless network are physically proximate to each other, they may likely share similar opinions on certain types of content and thus value recommendations of those nearby.

In one embodiment, after receiving the content, the mobile device attempts to contact a licensing server to determine if the content is licensed to them and/or to pay for the content. While contacting the licensing server, yet prior to determining the content is licensed for use by that mobile device or prior to paying for the content, the mobile device is able to use the content (or portion thereof). In essence, the mobile device user is able to use it for free until they are able to contact the licensing server. In one embodiment, this use only occurs as long as another active mobile device of the mesh network, such as the mobile device that provided the content or another mobile device, is active in (part of) the network.

In one embodiment, once the mobile device that received the content is able to access the licensing server, a determination can be made as to whether the content is licensed. If the content is not licensed, a transaction occurs to obtain a license and/or pay for the content automatically. In one embodiment, such a transaction occurs without any user interaction. This may be implemented by having the payment information already with or accessible by the licensing server.

More specifically, in one embodiment, the platform running on each mobile device in the mesh network is always monitoring its link layer as part of a discovery protocol that is being used. Each mobile device announces or advertises itself and its content and each mobile device monitors its link layer to determine when another mobile device is in the area (based on received advertising messages). When a new device becomes available, the new device broadcasts information indicative of its distributable content, which the other mobile devices in the mesh network obtain and display. Once a mobile device has been discovered, the mobile device that made the discovery maintains a list of all the mobile devices for which it is still communication and maintains information about the distributable content for each of the mobile device, which is received from each mobile device directly as part of the process. If the new device was a device that had previously been part of the group, the mobile devices recognize that this new mobile device was previously in the mesh network and displays their profile information again.

In one embodiment, the wireless mesh network uses a path selection protocol when a mobile device wants to communicate with another mobile device in the wireless mesh network. In this case, the mobile device sends a broadcast message that queries how to reach that other mobile device. In one embodiment, the path selection protocol computes a metric and creates a topology that can be used to determine a route for the communication when it needs to do so. Any message will then be forward along that determined route. In one embodiment, if the message is being sent through multiple mobile devices to reach its destination, then the message contains information indicating to the mobile devices that receive it that they need to forward the message onward to its destination.

When a mobile device leaves the group, the other mobile devices stop receiving the announcements from that mobile device and the mobile devices remove their information indicative of the content they had which was distributable from the displayed list of distributable content. In response to this occurring, notifications are sent to provide an indication that the mobile device is no longer available.

When any mobile devices of a group that has been split away from a mesh network are back within range, they automatically and seamlessly rejoin the group from which they split. This seamless rejoining does not require any reconnection process to occur because there was never a connection that was broken.

In one embodiment, in order to reestablish communication, a messaging library is used. In one embodiment, the library is zeromq.

In one embodiment, as an alternative to using a wireless mesh network, the wireless communication scheme that is used is WiFi or WiFi Direct+TDLS (Tunneled Direct Link Setup). In the case of WiFi, an access point (AP) is located nearby. This could be a fixed AP or one of the mobile devices (e.g., phones) configured in AP mode or a mobile hotspot.

### A Content Distribution and Deferred Payment Interaction

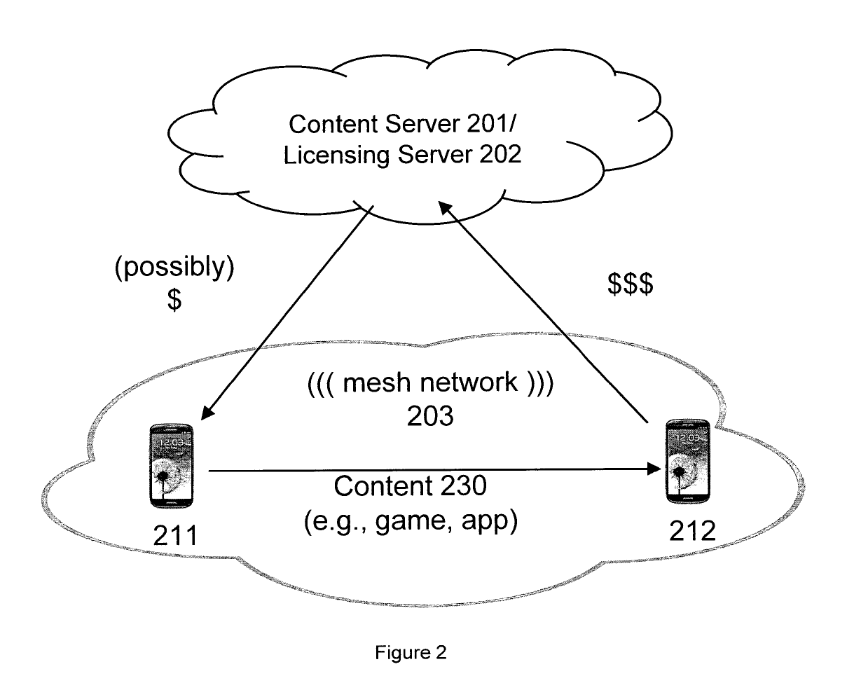

FIG. 2 illustrates an example of a mesh network. Referring to FIG. 2, a pair of mobile devices in mesh network 203, namely mobile device 211 and 212, are shown. Mobile device 211 transfers content 230 (e.g., a game, application, music, movie, etc.) to mobile device 212. Content 230 may have been obtained by mobile device 211 from content server 201 (e.g., appstore) over a separate network connection (e.g., an Internet connection). Mobile device 212 may be obtaining content 230 directly from mobile device 211 because mobile device 212 does not have access to content server 201. This may be due to a lack of network access by mobile device 212. Subsequently, mobile device 212 contacts licensing server 202 to obtain a license to and/or pay for content 230. This occurs after mobile device obtains network access to licensing server 202.

Mobile device 212 is able to make use of content 230 while in the process of contacting licensing server 202. That is, even if mobile device 212 is unable to contact licensing server 202 due, for example, to a lack of network access to licensing server 202, in one embodiment, mobile device 212 is able to continue to make use of the content. In one embodiment, mobile device 212 is only able to continue to use content 230 without obtaining a license and/or paying for content 230 while mobile device 211 remains active in mesh network 203. In another embodiment, mobile device 212 is only able to continue to use content 230 without obtaining a license and/or paying for content 230 while mobile device 211 remains active in mesh network 203 or at least one other mobile device in mesh network 203 that has a license to the content remains active in mesh network 203.

In one embodiment, content server 201 and licensing server 202 are the same server. In another embodiment, content server 201 and licensing server 202 are different servers. In such a case, these two servers are located at different network locations in a network. Note that in one embodiment content server 201 and licensing server 202 are part of a different network (e.g., a WAN, Internet, etc.) than mesh network 203.

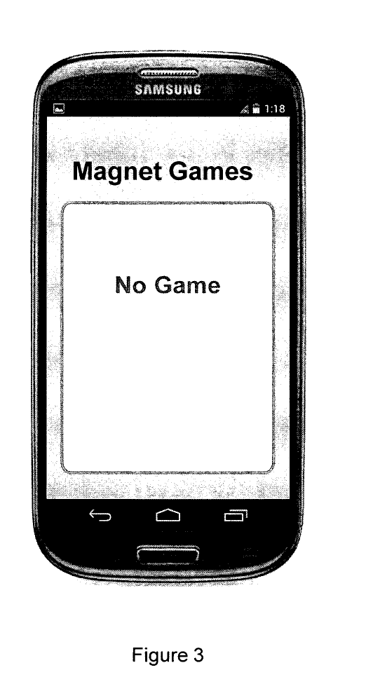

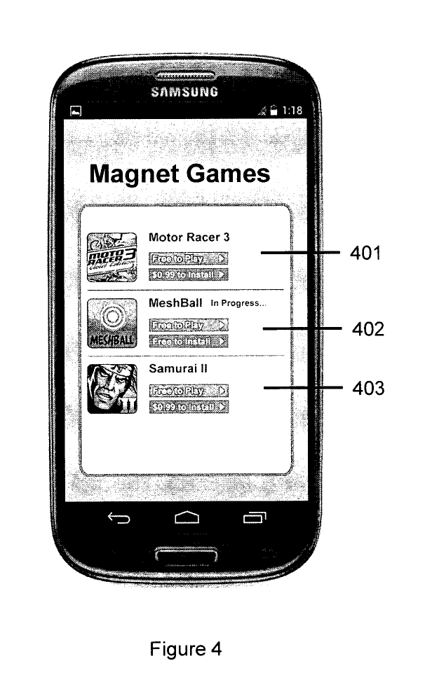

More specifically, in one embodiment, when a mobile device in the mesh network is in the discovery phase, the mobile devices obtains an indication, from other mobile devices in the mesh network that are advertising their content, of all the content that is available from other mobile devices in the mesh network. For example, if other mobile devices have games that can be distributed in the mesh network, those games are advertised by those mobile devices as part of using the mesh network. Thus, when a user with a mobile device enters the mesh network, they may initially show that there is no content (e.g., games) on their own device. FIG. 3 illustrates a display of a mobile phone indicating that no such content (e.g., games) are available for use. Subsequently, as shown in FIG. 4, the display of the mobile device becomes populated with the titles of games from other mobile devices in the mesh network that are distributable to the mobile device. Referring to FIG. 4, three game titles 401-403 are shown.

In one embodiment, the games and other content are usable for free by the mobile device as long as the mobile device from which it received the content is still active in the mesh network or another mobile device active in the mesh network has a licensed copy of the content. If the mobile device from which the content was received is no longer part of the mesh network and no other mobile device in the mesh network has a licensed copy of the content, the mobile device using the content for free will be unable to continue to use the content. In one embodiment, the distributable content may be used as long as there is a non-distributable version in the network.

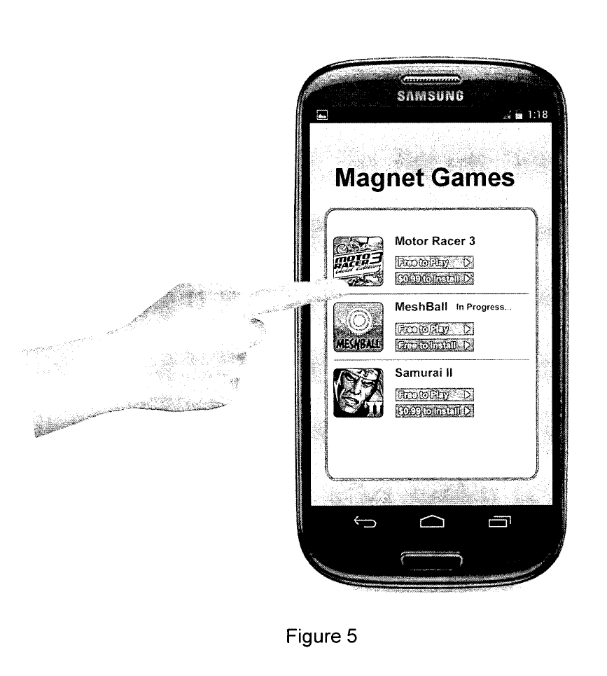

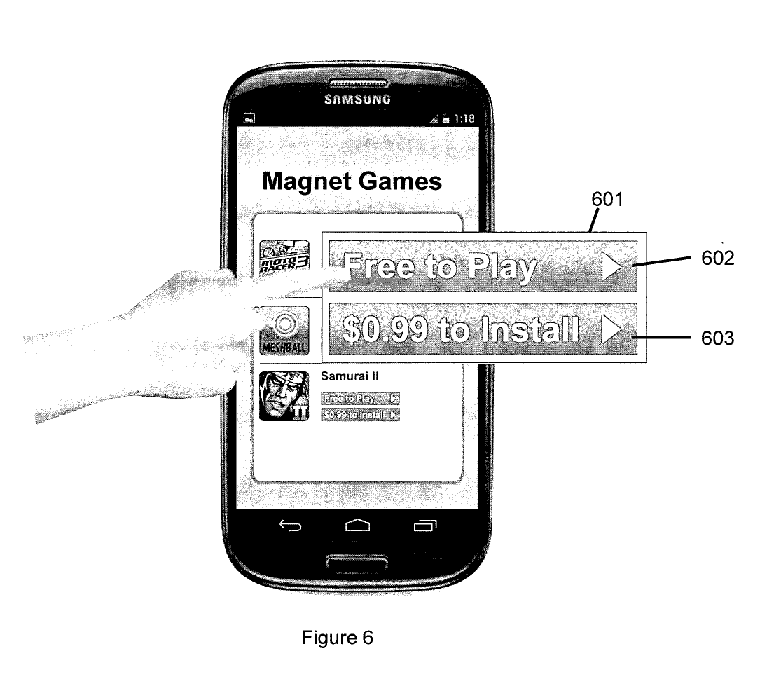

For example, in the case of the game example discussed above, if the user selects one of the games from the populated display from the advertisements from the other mobile devices in the mesh network, such as shown in FIG. 5, the user is prompted with an indication of whether they want to pay for the game or play for free. FIG. 6 illustrates a pop-up menu 601 that is displayed in response to selecting one game from the list of games on the display of the mobile device. Pop-up menu 601 displays a “Free to Play” button 602 and a “$0.99 to Install” button 603. By selecting the “Free to Play” button 602, the user of the mobile device is able to play the game for free while the mobile device that provided the game or at least one other mobile devices that has a license to the game remain active in (part of) the mesh network. When they are no longer active, the mobile device is no longer able to use the game.

In FIG. 6, if the user of the mobile device selects “$0.99 to Install” button 603, the mobile device user is opting to pay for an installation of the game to receive a licensed copy of the game. Assuming the mobile device has network access to a licensing server, communication with the licensing server begins and the user is able to pay for the game on the backend automatically with a typical payment transaction.

Thus, the user of the mobile device is able to obtain content distributed by other mobile devices in the network and obtain a licensed version of the content (e.g., games, media, etc.). Furthermore, other mobile devices in a network can permit other players to play the game free over the wireless mesh (or Wi-Fi) and these other players can play if they want the game installed on their mobile devices. This is particularly advantageous if the game is a multi-player game and they wish to play with other players in their vicinity.

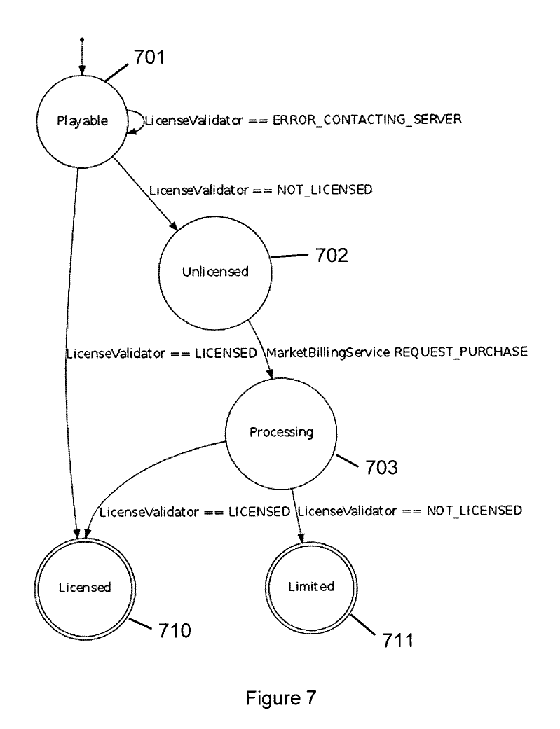

FIG. 7 is a state diagram that illustrates the transitions for a process of obtaining content and tracking the licensing of such content. The states and their transitions are on the device side that are performed by the licensing tracking code stored in the memory on the device. In one embodiment, the licensing tracking code is part of the content that is obtained by the mobile device from another mobile device in the network.

Referring to FIG. 7, playable state 701 is the state in which the mobile device is initially. After obtaining content, the mobile devices attempts to contact the licensed server. The mobile device stays in the playable state 701, being able to play the game without a determination of whether the game is licensed or not, and remains in this state while the mobile device is unable to contact the license server. In one embodiment, the mobile device is allowed to stay in this state indefinitely and play the game until such contact between the license server is made. In another embodiment, the user is allowed to play a certain number of times while remaining in playable state 701 and unable to contact the license server before they are no longer allowed to play the game. This could be implemented by using a simple counter that the code uses to keep track of the number of times the game has been played. In another embodiment, the user is not allowed to play the game or utilize the content while in playable state 701 until contact with the license server is achieved. In yet another embodiment, the user is allowed to play a limited version of the game while in playable state 701 and unable to contact the license server to determine whether the copy they have is licensed.

While in playable state 701, the mobile device keeps trying to contact the license server. When finally able to contact the license server (e.g., when network access to the license server is available), the license server provides an indication as to whether the content is licensed or not. If it is licensed, the mobile device transitions to licensed state 710 and can continue to use the content as it is a licensed version of the content. If the mobile device receives an indication that the content is unlicensed, the mobile device transitions to the unlicensed state 702.

Once at the unlicensed state 702, the mobile device attempts to cause payment for use of the content and transitions to the processing state 703 where the payment to obtain a license is taken care of in the background automatically. If the payment process is successful, the mobile device transitions from processing state 703 to the licensed state 710. If the payment processing is not successful, the mobile device transitions from processing state 703 to the limited state 711 in which the user is able to play or utilize the content as long as the mesh network includes at least one mobile device that has a licensed version of the content.

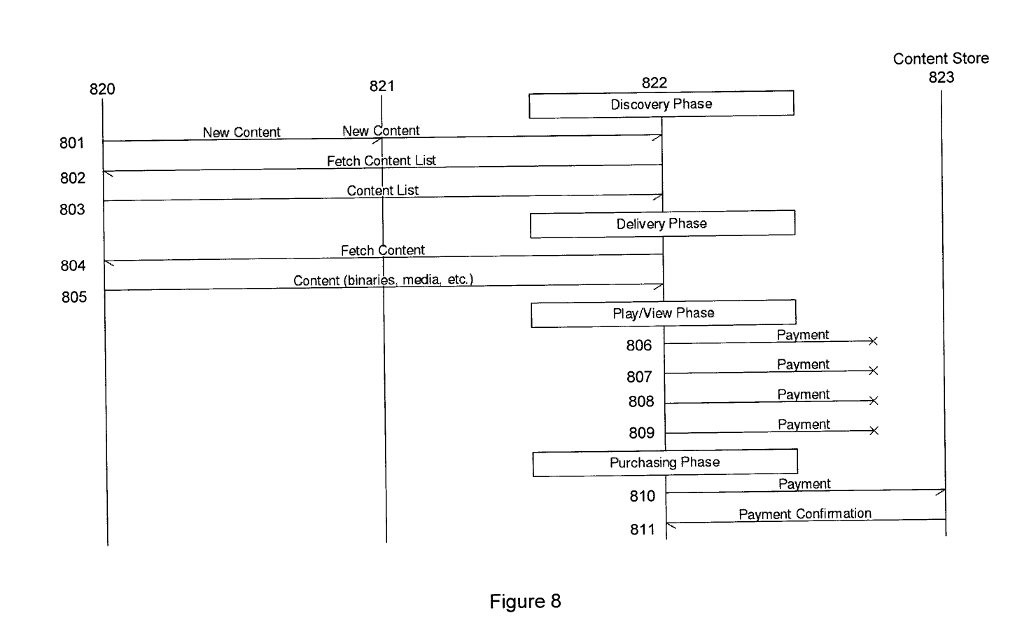

FIG. 8 illustrates one embodiment of the messaging that is used to implement portions of the obtaining and licensing content that is described above. This messaging scheme is performed by hardware (circuitry, dedicated logic, etc.), software (such as is run on a general purpose computer system or a dedicated machine), firmware or a combination of these on the mobile devices.

Referring to FIG. 8, the example illustrates three mobile devices 820, 821, and 822 and the content store 823. When mobile device 822 joins the mesh network, mobile device 822 enters a discovery phase. Mobile devices 820 and 821 both advertise their presence which includes an advertisement of distributable content that they have available. Mobile device 822 then determines that there is new content and requests a list of the content from 820 (message 802). In response thereto, mobile device 820 provides a content list to mobile device 822 (message 803).

Once mobile device 822 has the content list, it enters the delivery phase. During the delivery phase, mobile device 822 requests content from mobile device 820 (message 804). In response thereto, mobile device 820 provides the content to mobile device 822 (message 805). This content may be in the form of binaries, media, etc.

Once the content has been obtained from another mobile device, mobile device 822 enters the play/view phase. During the play/view phase, mobile device 822 is able to utilize the content while attempting to contact content store 823 to pay for and/or obtain a license to the content. As shown, mobile device 822 makes four unsuccessful attempts with messages 806-809 to contact content store 823.

Mobile device 822 enters the purchasing phase at message 810 when it is able to contact content store 823 and make a payment. In response thereto, content store 823 sends a payment confirmation (message 811). At this point, the content provided by mobile device 820 to mobile device 822 is licensed content.

Important to note that during the time between the play/view phase and the purchasing phase, mobile device 822 is able to use the content as long as mobile device 822 is a member of the mesh network or at least one other mobile device in the mesh network has a license to such content.

### One Embodiment of a Communication Process

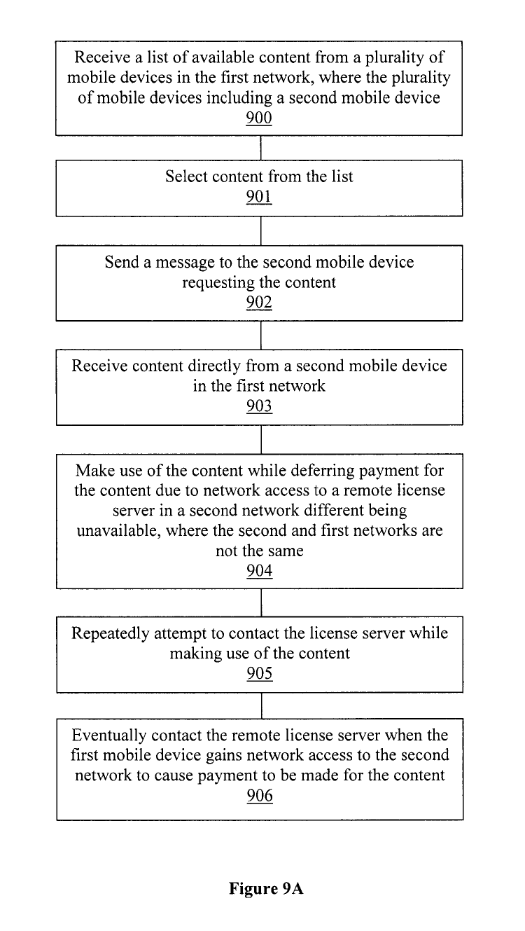

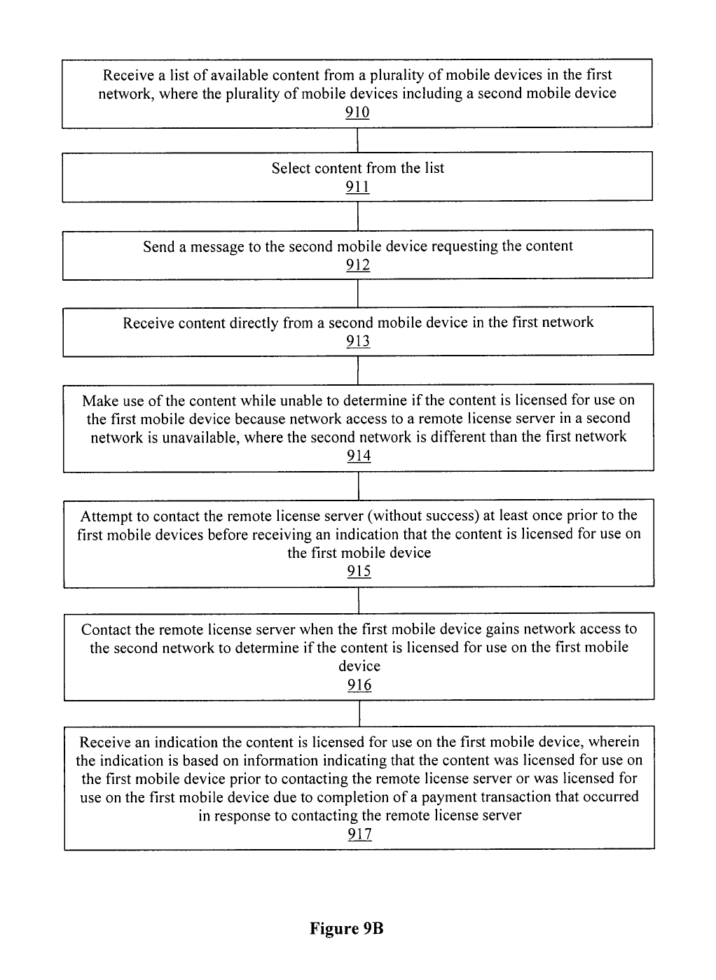

FIG. 9A is a flow diagram of one embodiment of a process for distributing content and deferring payment for the content. The process is performed by processing logic that may comprise hardware (circuitry, dedicated logic, etc.), software (such as is run on a general purpose computer system or a dedicated machine), firmware or a combination of these. In one embodiment, the process is performed by processing logic of a mobile device such as one of the mobile devices shown in FIG. 1.

Referring to FIG. 9A, the process begins by processing logic of a first mobile device in a first network receiving a list of available content from a plurality of mobile devices in the first network, where the plurality of mobile devices including a second mobile device (processing block 900). In one embodiment, the first network is a wireless mesh network. In another embodiment, the first network is a WiFi Direct network.

Next, processing logic in the first mobile device selects content from the list (processing block 901) and sends a message to the second mobile device requesting the content (processing block 902). In response to the message, processing logic in the first mobile device receives content directly from a second mobile device in the first network (processing block 903).

Processing logic makes use of the content by the first mobile device while deferring payment for the content due to network access to a remote license server in a second network different being unavailable, where the second and first networks are not the same (processing block 904). In one embodiment, making use of the content occurs as long as the first mobile device is active in the first network and at least one other mobile device active in the first network has a license to the content. In one embodiment, making use of the content comprises using a version of the content that has reduced functionality in comparison to a fully functional version of the content. For example, the functionality to support playing with multiple players may be disabled. In another embodiment, making use of the content comprises making use of the content a predetermined number of times while deferring payment and thereafter being prevented from using the content until payment is made for the content.

Processing logic repeatedly attempts to contact the license server while making use of the content (processing block 905) and eventually contacts the remote license server when the first mobile device gains network access to the second network to cause payment to be made for the content (processing block 906). In one embodiment, the payment is made for use of the content. In one embodiment, the payment is made to obtain a license for the content.

FIG. 9B is a flow diagram of an alternative embodiment of a process for distributing content and deferring payment for the content. The process is performed by processing logic that may comprise hardware (circuitry, dedicated logic, etc.), software (such as is run on a general purpose computer system or a dedicated machine), firmware or a combination of these. In one embodiment, the process is performed by processing logic of a mobile device such as one of the mobile devices shown in FIG. 1.

Referring to FIG. 9B, the process begins by processing logic of a first mobile device in a first network receiving a list of available content from a plurality of mobile devices in the first network, where the plurality of mobile devices including a second mobile device (processing block 910). In one embodiment, the first network is a wireless mesh network.

Next, processing logic in the first mobile device selects content from the list (processing block 911) and sends a message to the second mobile device requesting the content (processing block 912). In response to the message, processing logic in the first mobile device receives content directly from a second mobile device in the first network (processing block 913).

Processing logic in the first mobile device makes use of the content while unable to determine if the content is licensed for use on the first mobile device because network access to a remote license server in a second network is unavailable, where the second network is different than the first network (processing block 914). In one embodiment, making use of the content occurs as long as the first mobile device is active in the first network and at least one other mobile device active in the first network has a license to the content.

Processing logic attempts to contact the remote license server (without success) at least once prior to the first mobile devices before receiving an indication that the content is licensed for use on the first mobile device (processing block 915).

Subsequently, processing logic in the first mobile device contacts the remote license server when the first mobile device gains network access to the second network to determine if the content is licensed for use on the first mobile device (processing block 916).

Thereafter, processing logic in the first mobile device receives an indication the content is licensed for use on the first mobile device, wherein the indication is based on information indicating that the content was licensed for use on the first mobile device prior to contacting the remote license server or was licensed for use on the first mobile device due to completion of a payment transaction that occurred in response to contacting the remote license server (processing block 917).

### An Example of a Mobile Device

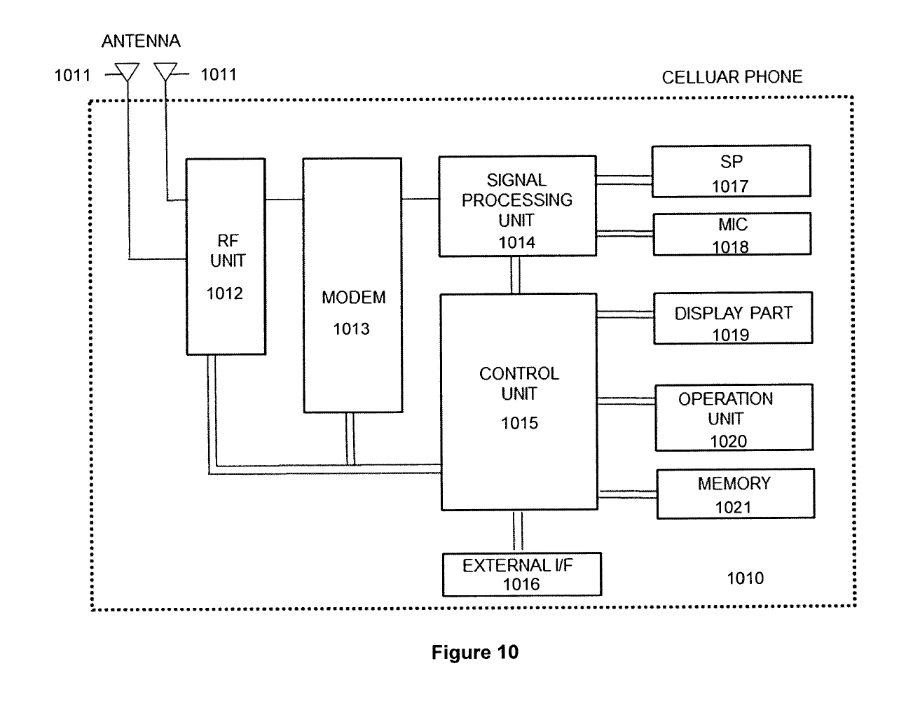

FIG. 10 is a block diagram of one embodiment of a mobile device (e.g., mobile phone) that includes a transmitter and/or the receiver. The mobile device may be part of a wireless mesh network that has multiple mobile devices operable to communicate directly with each other. In one embodiment, the mobile device comprises a first network interface operable for connection to the wireless mesh network, a second network interface operable for connection to a second network other than the wireless mesh network. The processor also includes a memory and a processor coupled to the network interfaces and the memory. In one embodiment, the processor receives content directly from another mobile device in the wireless mesh network; makes use of the content while deferring payment for the content due to network access to a remote license server in the second network being unavailable, where the second network is different than the first network; and contacts the remote license server when its able to gain network access to the second network to cause payment to be made for the content.

In one embodiment, the processor is operable to make use of the content as long as the first mobile device is active in the first network and at least one other mobile device active in the first network has a license to the content. In one embodiment, the payment is for a license to use the content.

Referring to FIG. 10, the mobile device 1010 includes an antenna 1011, a radio-frequency transceiver (an RF unit) 1012, a modem 1013, a signal processing unit 1014, a control unit 1015, an external interface unit (external I/F) 1016, a speaker (SP) 1017, a microphone (MIC) 1018, a display unit 1019, an operation unit 1020 and a memory 1021. In one embodiment, the external I/F 1016 includes an external interface (external I/F), a CPU (Central Processing Unit), a display unit, a keyboard, a memory, a hard disk and a CD-ROM drive. The CPU and the control unit 1015 in cooperation with the memories of mobile device 1010 (e.g., memory 1021, memory, and hard disk of the external I/F 1016) cooperate to perform the operations described above. Note that the transmitter and/or receiver may be included in other wireless devices (e.g., a wireless LAN).

In one embodiment, the memories of mobile device 1010 (e.g., memory 1021, memory, and hard disk of the external I/F 1016) store the code to gain access to the wireless or WiFi networks, including code to allow the mobile device to create, join, leave and rejoin a wireless mesh network, code for advertising itself and its content in the network, and code for exchanging messages and content with other devices and systems (e.g., servers) in these networks, and code for performing other operations described herein.

In one embodiment, the external I/F can be connected to a notebook, laptop, desktop or other computer. This can enable the user terminal to act as a wireless modem for the computer. The user terminal can be the computer's connection to the Internet, WiFi and WiMAX, a local area network, a wide area network, a personal area network, Bluetooth.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
receiving content at a first mobile device in a first network directly from a second mobile device in the first network;
making use of the content by the first mobile device while deferring payment for the content due to network access being unavailable to a remote license server in a second network different than the first network; and
contacting the remote license server when the first mobile device gains network access to the second network to cause payment to be made for the content.

2. The method defined in claim 1 wherein making use of the content occurs as long as the first mobile device is active in the first network and at least one other mobile device active in the first network has a license to the content.

3. The method defined in claim 2 wherein the first network is a wireless mesh network.

4. The method defined in claim 2 wherein the first network is a WiFi or WiFi Direct network.

5. The method defined in claim 1 wherein the payment is made for use of the content.

6. The method defined in claim 5 wherein the payment is for a license to the content.

7. The method defined in claim 1 further comprising:
receiving a list of available content from one or more mobile devices in the first network;
selecting the content from the list; and
sending a message to the second mobile device requesting the content.

8. The method defined in claim 1 further comprising: repeatedly attempting to contact the license server while making use of the content.

9. The method defined in claim 1 wherein making use of the content comprises using a version of the content that has reduced functionality in comparison to a fully functional version of the content.

10. The method defined in claim 1 wherein making use of the content comprises making use of the content a predetermined number of times while deferring payment and thereafter being prevented from using the content until payment is made for the content.

11. A method comprising:
receiving content at a first mobile device in a first network directly from a second mobile device in the first network;
making use of the content by the first mobile device while unable to determine if the content is licensed for use on the first mobile device because network access to a remote license server in a second network is unavailable, the second network being different than the first network;
attempting to contact without success the remote license server at least once prior to the first mobile devices receiving an indication that the content is licensed for use on the first mobile device;
contacting the remote license server when the first mobile device gains network access to the second network to determine if the content is licensed for use on the first mobile device; and
receiving an indication the content is licensed for use on the first mobile device, wherein the indication is based on information indicating that the content was licensed for use on the first mobile device prior to contacting the remote license server or was licensed for use on the first mobile device due to completion of a payment transaction that occurred in response to contacting the remote license server.

12. The method defined in claim 12 wherein making use of the content occurs as long as the first mobile device is active in the first network and at least one other mobile device active in the first network has a license to the content.

13. The method defined in claim 12 wherein the first network is a wireless mesh network.

14. The method defined in claim 12 further comprising:
receiving a list of available content from a plurality of mobile devices in the first network, the plurality of mobile devices including the second mobile device;
selecting the content from the list; and
sending a message to the second mobile device requesting the content.

15. A computer-readable non-transitory storage medium having instructions stored therein, which when executed by a network device, cause the network device to perform a method comprising:
receiving content at a first mobile device in a first network directly from a second mobile device in the first network;
making use of the content by the first mobile device while deferring payment for the content due to network access being unavailable to a remote license server in a second network different than the first network; and
contacting the remote license server when the first mobile device gains network access to the second network to cause payment to be made for the content.

16. The storage medium defined in claim 15 wherein making use of the content occurs as long as the first mobile device is active in the first network and at least one other mobile device active in the first network has a license to the content.

17. The storage medium defined in claim 16 wherein the first network is a wireless mesh network.

18. A mobile device for use in a wireless mesh network having a plurality of mobile devices operable to communicate directly with each other, the mobile device comprising:
a first network interface operable for connection to the wireless mesh network;
a second network interface operable for connection to a second network other than the wireless mesh network;
a memory;
a processor, coupled to the network interfaces and the memory, operable to:
receive content at a first mobile device in a first network directly from a second mobile device in the first network;
make use of the content by the first mobile device while deferring payment for the content due to network access being unavailable to a remote license server in a second network different than the first network; and
contact the remote license server when the first mobile device gains network access to the second network to cause payment to be made for the content.

19. The mobile device defined in claim 18 wherein the processor is operable to make use of the content as long as the first mobile device is active in the first network and at least one other mobile device active in the first network has a license to the content.

20. The mobile device defined in claim 18 wherein the payment is made for use of the content.
